(19) United States
(12) Patent Application Publication
(10) Pub. No.: US 2008/0320086 A1
(43) Pub. Date: Dec. 25, 2008

(54) SYSTEM AND METHOD FOR UPDATING INSTANT MESSAGE TRANSCRIPTS

(76) Inventors: Sean Callanan, Dublin (IE); Gary Denner, Kildare (IE); Daniel C. Gurney, Worcester, MA (US); Patrick J. O'Sullivan, Dublin (IE)

Correspondence Address: HOFFMAN WARNICK LLC, 75 STATE STREET, 14TH FLOOR, ALBANY, NY, 12207, US

(21) Appl. No.: 11/765,462

(22) Filed: Jun. 20, 2007

(51) Int. Cl. G06F 15/16

(52) U.S. Cl. 709/206

(57) ABSTRACT

The present invention provides a system and method for communications system, such as an instant messaging system, to allow encrypted conversations to be updated in real-time. The messages are encrypted with authentication keys or other security measures. The system and method provide the ability to modify an encrypted instant messaging conversation on the fly, where one user can seamlessly update the text without having to retype the full sentence or part of it. A sender's client may allow a sender client system to modify, for example, automatically or upon sender's input a message that has already been delivered to the recipients involved in the communication session. Once modified, the sender's client may allow the sender client system to deliver the revision to the recipients.

### FIELD OF THE INVENTION

The present invention relates generally to instant messaging systems and methods, more specifically, to improvements to systems and methods so that instant messaging conversations may be updated in real-time by modifying instant messaging (IM) transcripts.

### BACKGROUND OF THE INVENTION

Instant messaging (IM) is a form of real-time communication between two or more people based on typed text. The text is conveyed via computers connected over a network such as the Internet.

FIG. 1 illustrates a basic IM system 100. IM User A 102 wishes to communicate with IM User B 103. Instead of phoning, IM User A 102 uses instant messaging. Instant messaging allows IM User A's and IM User B's screens 102a, 103a to illustrate the IM “conversation” between IM User A 102 and IM User B 103. Instant messaging requires an instant messaging client 102b, such as IBM's Lotus Sametime® (see http://www-142.ibm.com/software/sw-lotus/sametime), generally installed on a general purpose computer (see http://computer.howstuffworks.com/pc.htm) which has a communications device that connects to an instant messaging (IM) server 106 via network 104. (However, the IM Devices 102c, 103c don't need to be personal computers as it can as easily be a cell phone, PDA and the like.) Like many servers, IM Server 106 has a network input/output device 112 to receive and send messages, one or more CPUs 114, databases 118 to store IM messages (110) and other data related to the IM session, and an internal bus 114 like other computers. IM User A Data 110 is stored in databases 118 and is forwarded to IM User B 103 to be displayed on IM Device 109 on IM User B's Screen 103b. Also, according to typical security procedures, IM User A has a Key 115, IM User B 116 has a key, and IM Server 106 has a Key 118 for authentication purposes.

Sometimes, however, a user will have many IM screens (with many users) at the same time. For instance, User A 102 maybe a support engineer working for a large organization. A great deal of his time may be spent in his instant messaging client 102b getting assistance from engineers in the development, test and support teams. It is not unusual for User A 102 to have 10 or more instant messaging chat windows open at any given time. Often User A will type test into the chat window and send it and then realize that he has not explained himself properly or had just put in a confusing typo. These mistakes usually bring the conversation off in a tangent which wastes time. Many times User A 102 commits his contribution before he reviews it because he feels under pressure to send something in case the person he is chatting with thinks he has left the chat. Also, there is network latency which may cause one contribution to be seen after the previous issue was being addressed. This can cause a ping-pong effect in an IM conversation which is causes IM user and frustration loss of productivity for the IM users.

There is a need to correct the chat text after it has been entered and to allow the ability to enter corrections on the fly, conventional systems today fail to furnish users with this ability and conventional IM systems today would greatly benefit from this.

There is a need to have a system which would help people with dyslexia as once correct spellings were entered they would only have to type some of the word and the correction would be done from the back-end data store.

There is a need to have a system for streaming text as it is being typed. This way the other person will know that the other user is typing and not gone away from the chat.

In view of the foregoing, a need exists to overcome these problems by providing a system and method for correcting the chat text after it has been entered and to allow the ability to enter corrections on the fly.

### BRIEF SUMMARY OF THE INVENTION

The present invention provides a system and method so that instant messaging conversations may be updated in real-time. The system and method provide the ability to modify an instant messaging (IM) conversation on the fly, where one user can seamlessly update the text without having to retype the full sentence or part of it. A sender's client may allow a sender client system to modify, for example, automatically (e.g., as a result of a software process) or upon sender's input (e.g., a sequence of at least one click or keystroke) a message that has already been delivered to the recipients involved in the communication session. Once modified, the sender's client may allow the sender client system to deliver the revision (e.g., the modified message, the original messages plus the modifications, or the modifications only) to the recipients. Along with the revision, the sender's client may deliver also an identification of the original message that has been revised (e.g. the unique ID, the time-stamp, or the sequential position of the message.) Typically, after a revision has been delivered, all clients participating in the communication (i.e. the recipient's client, or recipients' clients, and the sender's client) display the revised message.

The form in which the revised message is displayed may be selected by the sender's client system. The form in which the revised message is displayed may vary from client to client depending upon the parameters set for each client (i.e., parameters related on how a revised message is displayed) by, for example, the client system (e.g., automatically or upon user input), that may override the sender's client system selection. Typically, an instant message client displays a revised instant message differently from an unrevised one with the purpose to bring revisions to the attention of the user, and so not to be mistaken for original content. Also typically, when a revised message doesn't override the display of the original message, the original message is, for example, marked, strikeout, or otherwise displayed as superseded by the revised message.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 is a diagram which illustrates an instant messaging chat session.

FIG. 2 is a diagram which illustrates an IM User providing a contribution to the IM conversation.

FIG. 3 illustrates a block diagram showing the steps of the process of the present invention.

FIG. 4 illustrates a sample IM session 400 using the system and method of the present invention.

FIG. 5 illustrates an IM conversation between two IM users wherein one IM user notices another IM user's contributions, which are streamed to the first IM user, and makes modifications to the IM conversation.

FIG. 6 illustrates an IM conversation between two IM users wherein one IM user's contributions or modifications are displayed.

The drawings are intended to depict only typical aspects of the invention, and therefore should not be considered as limiting the scope of the invention. In the drawings, like numbering represent like elements between the drawings.

### DETAILED DESCRIPTION OF THE INVENTION

The present invention provides a system and method so that instant messaging conversations may be updated in real-time. The system and method provide the ability to modify an instant messaging (IM) conversation on the fly, where one user can seamlessly update the text without having to retype the full sentence or part of it.

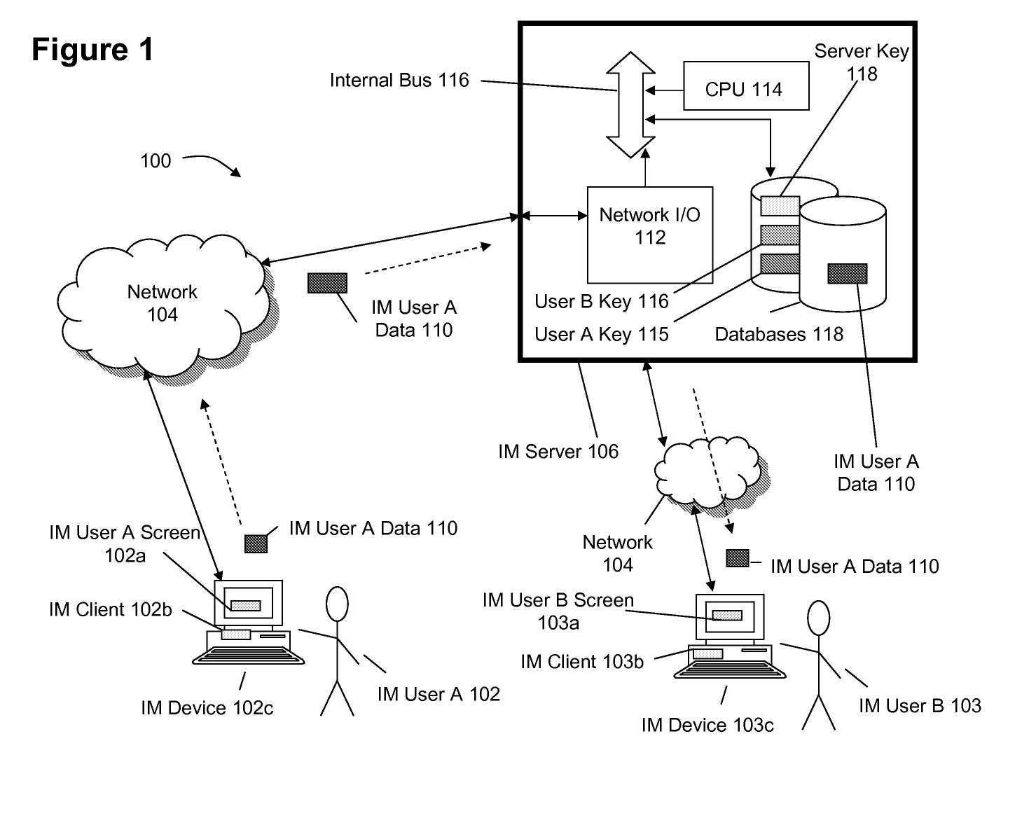

FIG. 1 is a diagram which illustrates an instant messaging chat session 100. It has an IM User A 102 communicating with an IM User B 103 via Networks 104 and IM Server 106. IM User A 102 has IM User Device 102c which includes IM Client 102b. It further has an IM User A Screen 102a for displaying the IM conversation. Similarly, IM User B 103 has IM User Device 103c which includes IM Client 103b. IM User A 102 sends to IM User B 103 text or other graphics messages that are displayed on IM User B's 103 screen 103a. For instance, if IM User A 102 wishes to send to IM User B 103 a message, a IM User A Data 110 comprising the message is sent. It is passed to the IM Server 106 and processed and passed to IM User B 103.

The IM User A Data 110 is passed through the IM Server 106 where it is processed. The IM User A 102 and IM User B 103 have already been authenticated by IM Server 110 using, in part, IM User A Key 115, IM User B 116 and IM Server Key 118. Data also included in the IM conversation is an identifier so that the chat session is uniquely identified and sequentially. The users can then reconvene the meeting at a later stage and any contribution added at that point would be uniquely identified as part of that later session but it would be possible still to make edits to the earlier transcript. Given that each contribution is tracked in a sequential way but the updates can happen anywhere in the transcript, the system allows the replaying the transcript in a step by step mode. This allows users to replay the chat to figure out when a particular contribution was added.

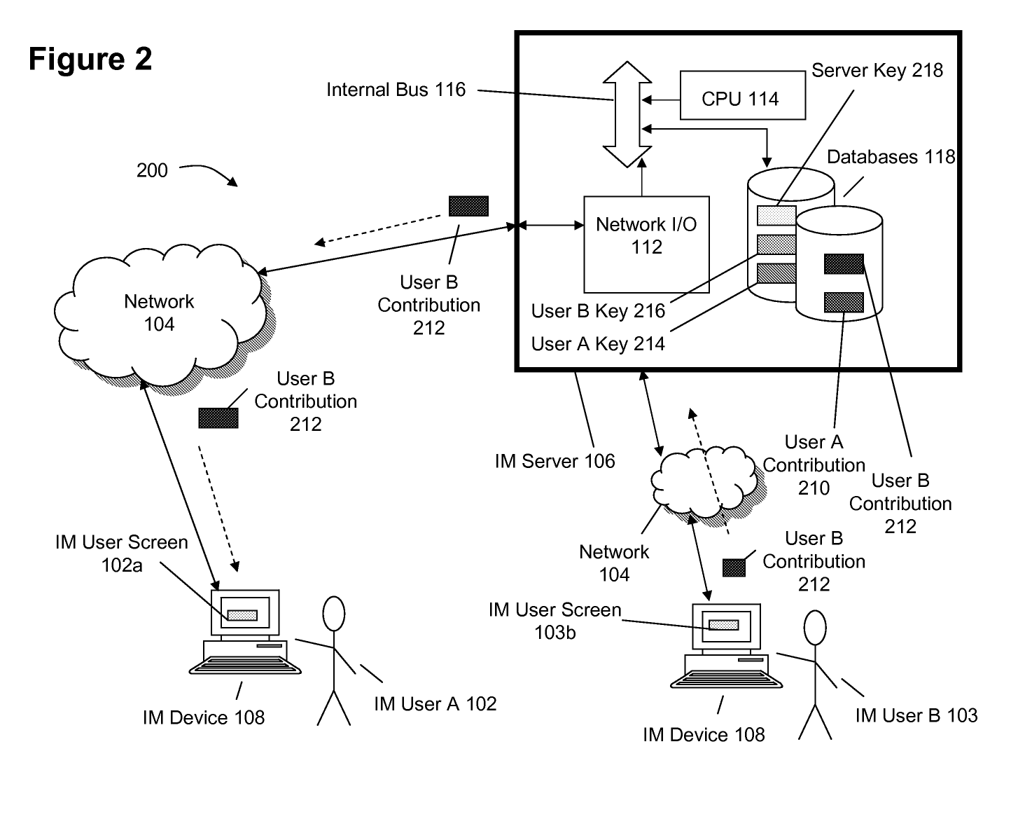

FIG. 2 is a diagram which illustrates IM User B 103 providing a contribution to the IM conversation. IM User's B 103 Contribution 212 is passed through IM Server 106, while being stored and processed in IM Server 106, to IM User A 102. The storing and processing of the IM conversation, or transcript, provides the ability to correct the chat text after it has been entered by adding a new transcript version. This allows the user to correct mistakes or clarify points in previous chat without altering the original transcript. A versioning system shall be used to track the edits made by each user.

The changes to a document are tracked so that the person who made those changes is known. Other systems could utilize this invention. For example, it could be utilized to store changes to an email such as when User A mails User B, User B replies with the original contents and some edits. The system can be utilized to prove that User B added his sections and User A added his even if they are intermingled in the one email, because they would be no different to an updated chat transcript.

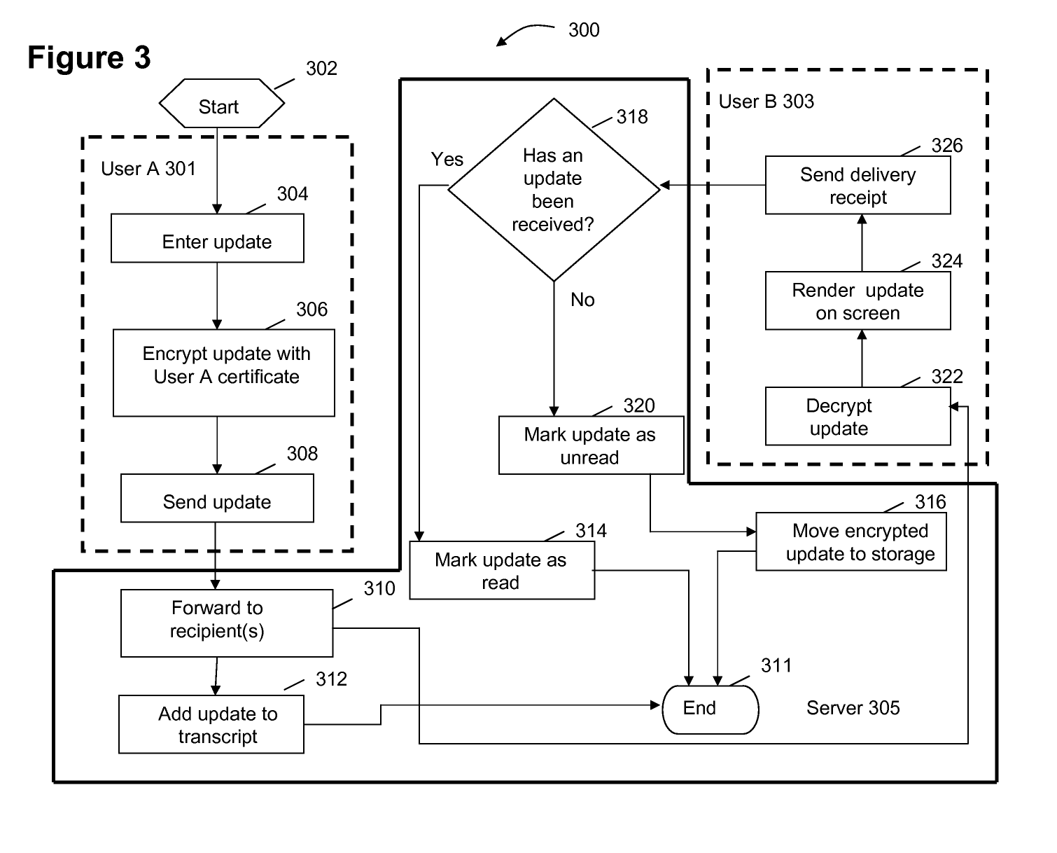

FIG. 3 illustrates a block diagram showing the steps of the process 300 of the present invention. Using the Process 300, User A 301 is able to chat with User B 303 through Server 305. At 302, the process 300 starts and continues to step 304 where User A 301 enters an update to the IM session, is encrypted at 306 and is sent at 308. This update is displayed on User B's IM transcript display window. It should be noted that the update may be done automatically using a software process.

At 310, the IM update is received by Server 305 and forwarded to recipient(s). At 312, the update is added to the transcript and the process ends at 311. At User B's IM client, the IM update is decrypted at 322, the update is rendered on User B's display and a delivery receipt is sent to Server 305. At 318, the Server 305 determines whether the updates have been received by the intended recipients and, if so, at 314, marks the update as being read and the process ends at 311. If not, at 320, the Server 305 marks the update as being unread and moves the update to encrypted storage at 316 and the process ends at 311.

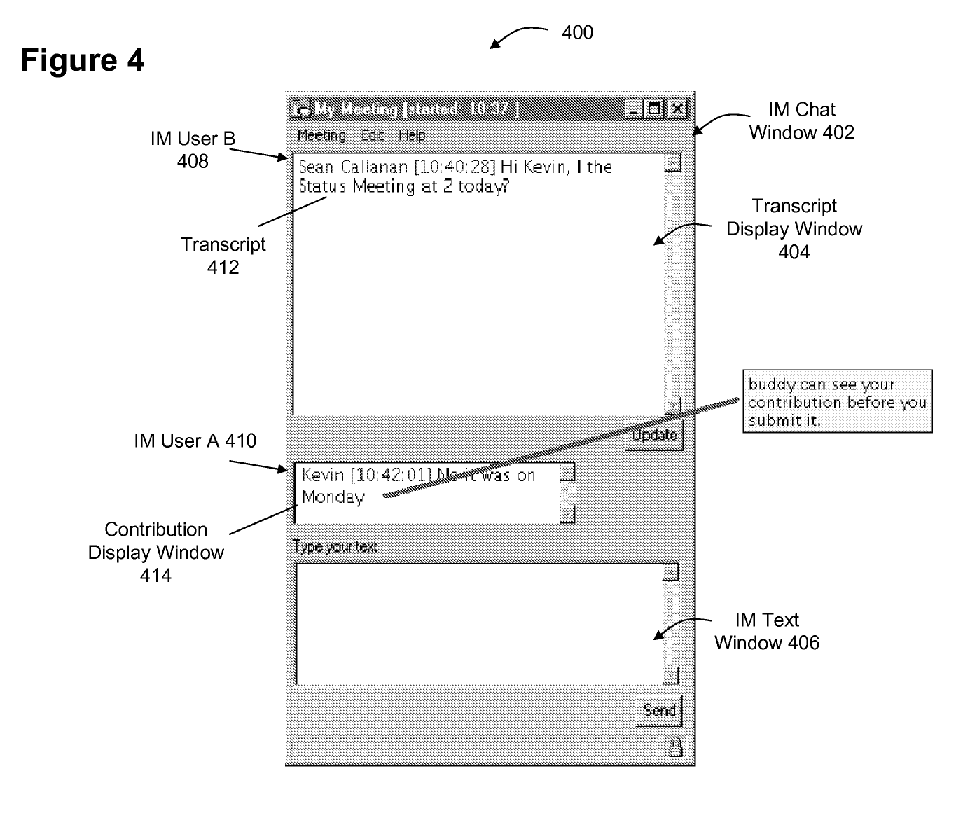

FIG. 4 illustrates a sample IM session 400 using the system and method of the present invention. IM Chat Window 402 comprises a Transcript Display Window 404 for displaying the Transcript 412 of the IM session, an IM Text Window 406 for displaying IM User A's IM (Kevin's), and a Contribution Display Window 414 for displaying IM User A's Contributions. IM User A (Kevin) 410 and IM User (Sean) B 408 are displayed on the IM Chat Window 402. IM User A 410 typically types his IM text in IM Text Window 406. However, he may choose to select to make a contribution, such as a modification to an existing IM conversation. If that is the case, he chooses to type his text in Contribution Display Window 414. If he chooses to type his text in Contribution Display Window 414, his IM partner (IM User B in this case) can see his text immediately due to streaming technology. Alternatively, IM User A 410 may type his modifications directly in Transcript Display Window 412—the modifications being shown in a different color or in different font.

The initial message from IM User B 408 to IM User A 410 is shown in Transcript Display Window 412 and IM User A's 410 contribution in Contribution Display Window 414. IM User B 408 can see IM User A's 410 contribution immediately or in real time so that the conversation may progress in an orderly manner. In this way, IM users may correct the chat text after it has been entered by adding a new transcript version. This allows the user to correct mistakes or clarify points in previous chat(s) without altering the original transcript. A versioning system is used to track the edits made by each other. This allows the ability to enter corrections on the fly. In the preferred embodiment, the transcript of the chat cannot include changes from outside of the context of the chat or from non-chat participants. To achieve this, the contributions for each partner in the chat are encrypted using their own certificate they are stored in the chat transcript and further encrypted using the server's certificate. This ensures that only the server can add contributions to the chat and only each individual participant can create their own contributions. All public keys are stored in the transcript so it can be viewed at a later stage even outside the server. This provides the ability to prove that a given contribution was added by a particular person at a particular time in the meeting.

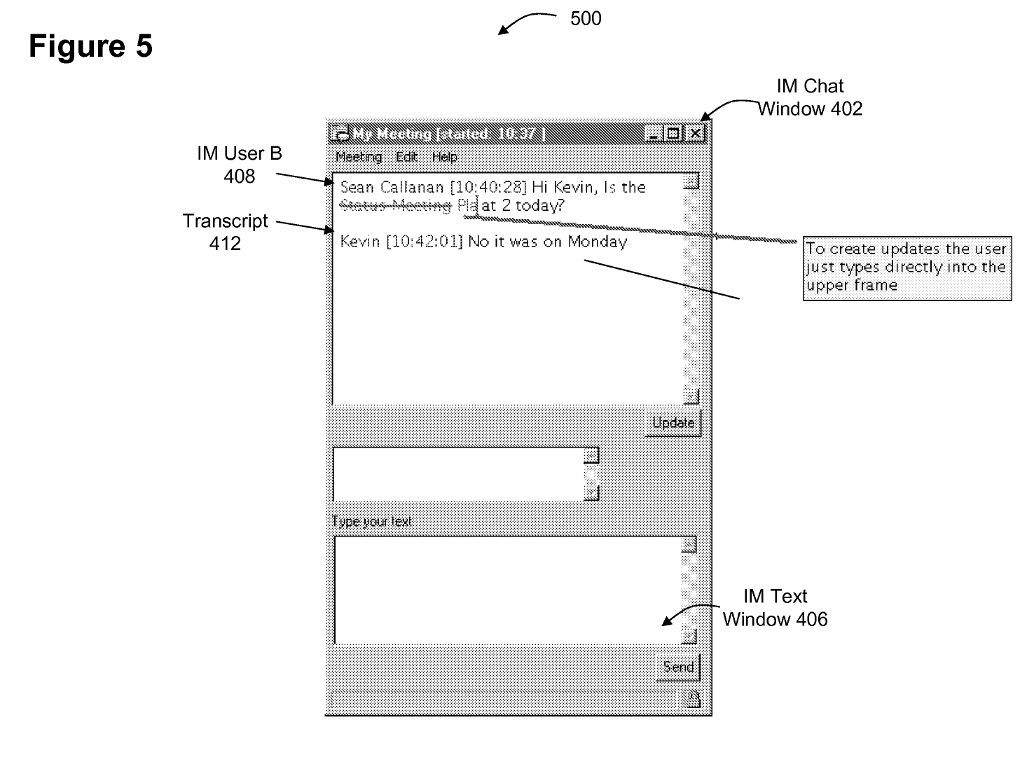

FIG. 5 illustrates the IM conversation between IM User A 410 and IM User B 408 wherein IM User B 408 notices IM User A's 410 contributions, which are streamed to IM User B 408, and makes modifications to the IM conversation. IM User B 408 can make those changes in his Contribution Display Window 414 or directly in his Transcript Display Window 404. The modifications can be highlighted—such as in a different color or in a different font—to indicate that the IM conversation has been modified.

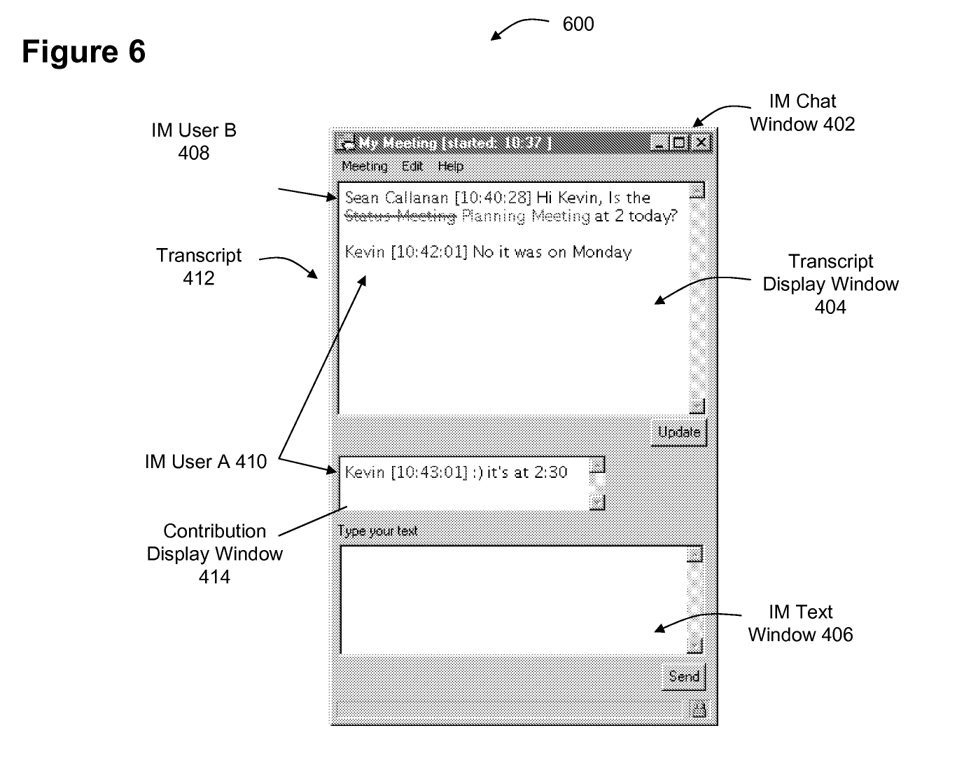

FIG. 6 illustrates the IM conversation between IM User A 410 and IM User B 408 wherein IM User B's 408 contributions or modifications are displayed. The contributions, or changes, are highlighted to give notice to the receiver(s) of the changes. Shortly thereafter, IM User A's 410 contribution is displayed in Contribution Display Window 414. This can be seen in real time by IM User B 408 due to streaming technology so that an active conversation can take place and that the transcript may be saved for future reference.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method, in a communications system such as an instant messaging (IM) system, having two or more IM users, for passing messages (IMs) from one IM user to another, each IM user having a user interface (UI) for displaying his IM message, for receiving an IM sender contribution from a sending IM user and for passing those along to the intended receivers IM users, to an IM conversation, and for allowing a real time modification of previously sent IM messages and sending the IM modifications for display on IM users screen, the method comprising the steps of:
a. establishing an instant messaging conversation between at least two users where a first user is able to communicate with a second user;
b. allowing the first IM user and the second IM user to have an IM conversation forming a transcript;
c. saving the transcript of the IM conversation;
d. sending, in real time, the transcript to each of the one or more IM users the IM transcript for display on the user's UI;
e. receiving, from one of the users, a modification to the IM conversation (IM modification) in the midst of the IM transcript; and
f. sending to each of the one or more IM users the modification to the IM transcript for display.

2. The method of claim 1 further including the step of highlighting the IM modifications in a different color than the general conversation.

3. The method of claim 2 further including the step of highlighting an issue based upon a different noise from one of the participants.

4. The method of claim 1 further including the step of allowing IM users whether to decide if they want to take part in chats that have the ability to be updated.

5. The method of claim 1 further including the step of encrypting chat transcripts so it can be proven that these were the only edits that happened in the chat session.

6. The method of claim 1 further including the step of reporting back to the sender if an update could not be delivered because the receivers chat window had lost the original text and the receiver does not allow updates.

7. The method of claim 1 further including the step of allowing a user to save transcripts with the edits intact.

8. The method of claim 8 further including the step of saving or caching edits in a background data store so when users are typing the same words again the data store will know what they typed previously and auto correct it for them.

9. The method of claim 1 further including the step of replaying the transcript and see updates in the sequence they were added originally.

10. The method of claim 1 further including the step of streaming it is being typed so that the other person will know that you are typing and not gone away from the chat.

11. A computer program product in a computer readable medium for operating in a system comprising a network I/O, a CPU, and one or more databases, for implementing a method, in a communications system such as an instant messaging (IM) system, having two or more IM users, for passing messages (IMs) from one IM user to another, each IM user having a user interface (UI) for displaying his IM message, for receiving an IM sender contribution from a sending IM user and for passing those along to the intended receivers IM users, to an IM conversation, and for allowing a real time modification of previously sent IM messages and sending the IM modifications for display on IM users screen, the method comprising the steps of:
a. establishing an instant messaging conversation between at least two users where a first user is able to communicate with a second user;
b. allowing the first IM user and the second IM user to have an IM conversation forming a transcript;
c. saving the transcript of the IM conversation;
d. sending, in real time, the transcript to each of the one or more IM users the IM transcript for display on the user's UI;
e. receiving, from one of the users, a modification to the IM conversation (IM modification) in the midst of the IM transcript; and
f. sending to each of the one or more IM users the modification to the IM transcript for display.

12. The computer program product of claim 11 further including the step of highlighting the IM modifications in a different color than the general conversation.

13. The computer program product of claim 12 further including the step of highlighting an issue based upon a different noise from one of the participants.

14. The computer program product of claim 11 further including the step of allowing IM users whether to decide if they want to take part in chats that have the ability to be updated.

15. The computer program product of claim 11 further including the step of encrypting chat transcripts so it can be proven that these were the only edits that happened in the chat session.

16. The computer program product of claim 11 further including the step of reporting back to the sender if an update could not be delivered because the receivers chat window had lost the original text and the receiver does not allow updates.

17. The computer program product of claim 11 further including the step of allowing a user to save transcripts with the edits intact.

18. The computer program product of claim 11 further including the step of saving or caching edits in a background data store so when users are typing the same words again the data store will know what they typed previously and auto correct it for them,

19. A system, in a communications system such as an instant messaging (IM) system, having two or more IM users, for passing messages (IMs) from one IM user to another, each IM user having a user interface (UI) for displaying his IM message, for receiving an IM sender contribution from a sending IM user and for passing those along to the intended receivers IM users, to an IM conversation, and for allowing a real time modification of previously sent IM messages and sending the IM modifications for display on IM users screen, the system comprising:
a. databases for storing an IM conversation and transcript;
b. a CPU for allowing the first IM user and the second IM user to have an IM conversation forming a transcript, saving the transcript of the IM conversation, sending, in real time, the transcript to each of the one or more IM users the IM transcript for display on the user's UI, receiving, from one of the users, a modification to the IM conversation (IM modification) in the midst of the IM transcript, and sending to each of the one or more IM users the modification to the IM transcript for display.

20. The system of claim 19 further including the step of highlighting the IM modifications in a different color than the general conversation.
